(19) United States
(12) Patent Application Publication
(10) Pub. No.: US 2026/0045750 A1
(43) Pub. Date: Feb. 12, 2026

(54) Method of Attaching a Cable Connector

(71) Applicant: WELLADSEN BROS PTY LTD, Bligh Park (AU)

(72) Inventors: Thomas John WELLADSEN, Bligh Park (AU); Peter Frederick REYNOLDS, Sydney (AU)

(21) Appl. No.: 19/326,995

(22) Filed: Sep. 12, 2025

Related U.S. Application Data
(63) Continuation-in-part of application No. PCT/AU2024/050220, filed on Mar. 14, 2024.

(30) Foreign Application Priority Data
Mar. 14, 2023 (AU) 2023900685

(51) Int. Cl. H01R 43/02; H01R 4/02; H01R 4/72; H01R 24/54; H01R 103/00

(52) U.S. Cl. CPC H01R 43/0235; H01R 4/024; H01R 4/723; H01R 24/542; H01R 2103/00

(57) ABSTRACT

A method of preparing a cable and a connector and, more particularly, to a method of making a cable with a connector. The method connects an end connector to a respective end of at least one of a first and a second conductor. The method comprises applying a dielectric sealant to the whole of one or more electrical joints in the audio cable jack connection to thereby hermetically seal the joints. The method comprises completely coating one or both the first and second joints with a liquid, viscous, fluid, or otherwise paintable insulation, thereby hermetically sealing the cable joints so that the joints are protected from corrosion, oxidation, and/or other types of atmospheric attack, the joints are strengthened, and degradation of an electrical signal carried on the cable is reduced.

### CROSS-REFERENCE TO RELATED APPLICATIONS

The present application claims priority from Australian Provisional Patent Application No 2024901521 filed on 23 May 2024, the contents of which are incorporated herein by reference.

### TECHNICAL FIELD

The present disclosure broadly relates to a method of making a cable and, more particularly, to a method of connecting a cable and a cable connector.

### BACKGROUND

Audio cables such as those used with a musical instrument, a microphone, a speaker cable, a studio patch cable, or the like, are designed to transmit relatively low-level audio signals from one device to another, such as a signal from an electric guitar which is then transmitted to the guitar amplifier. End connectors or plugs are connected to both ends of the cable by attaching the cable conductors to the end connector.

Physical stress on the cable being handled repetitively (such as being plugged and unplugged) can damage the cables. This damage can become a source of noise affecting the audio quality of the cable, e.g. by varying and degrading the frequency response of the cable. This is a real problem because instrument and microphone cables are used at the beginning of the amplification process, so any noise, no matter how small, is amplified over and over again before it reaches the speakers and human ear.

Oxidation, corrosion and atmospheric attack occurs when a cable's copper and solder joints are exposed to the environment due to old and current methods of making cables and guitar wiring. This corrosion affects the electrical and structural integrity of the industry standard oxygen free copper (OFC) audio plug and cable make up. Sonically it is very significant and the use purpose of the cable becomes redundant once the chemical reaction of oxidation occurs when the cable is corroded. The structural integrity of an audio cable is negatively affected by corrosion.

Typically, the user accepts the damage as general wear and tear or due to the cable being made from subpar materials or workmanship. In many cases, the user simply throws out the damaged cable and replaces it with a new cable.

Similarly, handling of the audio cable and the repetitive plugging and unplugging of a plug or end connector into an output jack can damage the output connection, affecting the audio quality of the connection. In these cases, the user simply has the output jack or the wiring kit replaced.

Methods of making audio cables which are less prone to failure and provide high sonic quality are desirable. Similarly, in addition to audio cables, the reliability and quality of connections are a concern for cables used in a wide range of electronic applications, including power transmission, data communication, and signal processing. Poorly made connectors or degraded contact points can introduce resistance, intermittent connections, signal loss, and/or electrical noise, which in turn can compromise the performance of the entire system. Just as in audio cables, repeated mechanical stress, environmental exposure, or substandard materials can accelerate degradation in these connections, highlighting the importance of designing connectors and cables with durable materials, precise construction, and protective measures that maintain consistent electrical and mechanical integrity over time. Accordingly, the methods described herein are aimed at improving connections between a cable and an end connector.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

The present invention is directed towards a method of making or repairing a cable such as audio cables, USB cables, coaxial cables, RJ45 cables, HDMI cables, power cables, Thunderbolt cables, etc, that have an end connector. The improved method may be used in making, repairing, or otherwise preparing the attachment between the cable and the end connector in a manner which may at least partially overcome at least one of the abovementioned disadvantages or provide the consumer with a useful or commercial choice.

Although described with respect to electrically conductive components and copper cables, the method described herein may also be applied to other types of cables such as optical cables and associated nodes and connectors. Indeed, particularly in rugged and/or corrosive environments, using a liquid sealant to hermetically seal components improves the sealing mechanism due to the liquid being able to completely coat any shape or configuration of components in order to seal the components and ensure that the components remain impervious to gas, water, moisture and the like.

The hermetic sealing methods described herein involve the application of liquid hermetic encapsulation during the manufacturing stage, so that the liquid penetrates all accessible parts around solder joints for structural enhancement, support, and hermetic sealing. The liquid sealant cures into a permanent yet flexible hermetic seal.

The plug assembly of a cable is the end piece that allows the cable to connect to a device, jack, or port, serving as both a mechanical and electrical interface. It consists of contact pins or conductors that physically touch the corresponding contacts in the device, carrying electrical signals such as audio, data, or power. The connector housing, which surrounds and protects the contacts, provides mechanical strength and ensures proper alignment when inserted, and its material and plating can affect durability, corrosion resistance, and conductivity. Strain relief, for example in the form of a moulded rubber or plastic sleeve, may be used to protect the cable from bending sharply or breaking at the point where it enters the plug. Internal insulation prevents short circuits between contacts and maintains the correct spacing between conductors. In some embodiments, retention features such as locking mechanisms or threads may be used to keep the plug securely connected and prevent accidental disconnection. Overall, the plug assembly ensures reliable signal transmission while protecting both the cable and the connected device.

Described herein is a method of hermetically sealing the connection between a cable and its plug assembly in order to protect against oxidation and atmospheric attack. This protects the cable and whole makeup of the product from corrosion, oxidation, and/or other types of atmospheric attack.

As used herein, the term “hermetically sealed” refers to a surface that is coated in such a way to be impervious; specifically, the surface is made airtight to prevent the passage of gases or liquids into or out of the sealed space. Hermetic sealing ensures that an interior environment remains isolated and protected from external factors such as moisture, gases, and/or contaminants.

In a first aspect, there is provided a method of connecting an end connector to a respective first and a second conductor of a cable having at least one of: a cable shield and a cable jacket, the method comprising:
conditioning the end connector contact region with a contact conditioner;
applying a solder and then a flux paste to the contact region of the end connector;
joining an end of the first conductor to a ground contact of the end connector to form a first joint, and joining the second conductor to a live region of the end connector to form a second joint, wherein the second conductor conducts an electrical signal, and
coating one or both the first and second joints with a liquid or viscous sealant, up to an edge of at least one of the cable shield and/or the cable jacket so that no gap remains between (a) the first and/or second conductor and (b) the cable shield and/or cable jacket of the cable to thereby hermetically seal the cable joints, making the joints impervious to liquid or gas, so that the joints are protected from corrosion, oxidation, and/or other types of atmospheric attack.

Surprisingly, the applicant has observed that soldered connections are susceptible to corrosion which can weaken the audio cable and/or the connection between the cable and its jack, as well as be a significant source of noise affecting the sonic quality of the cable and/or jack. This is the case even though the joints are inside the connector and are not exposed to the elements. It is believed that changes in humidity and temperature during performances or during touring can cause condensation in the cable connector, exposing the soldered connection to moisture. Further, it is believed that microscopic amounts of moisture can initiate the corrosive process by combining with residues from the solder process, as well as acting as an electrolyte and causing galvanic corrosion between the solder, copper wire and plug contacts.

The method is directed to manufacturing an audio cable having an end connector connected to a respective end of a first and a second conductor.

The audio cable may be of any suitable type. For instance, the audio cable may be a coaxial cable, a twin-axial cable, a triaxial cable, a twisted pair or the like. In some embodiments described herein, the audio cable may be a coaxial cable.

The audio cable may comprise a first conductor and a second conductor. In use, it will be understood that at least one conductor may comprise an earth or ground wire, and at least one conductor may comprise a signal carrying voltage wire. In some embodiments, the audio cable may further comprise a third conductor, for example where two conductors may comprise signal wires and a third conductor may comprise a ground wire. In this instance, the at least two conductors may comprise a positive signal wire and a negative signal wire.

In embodiments wherein the audio cable is a coaxial cable, the second conductor may be surrounded by at least one insulating layer which separates the second conductor from the first conductor. In other embodiments, the first conductor and the second conductor may each have at least one insulating jacket. A portion of the insulating jacket (or jackets), may be removed in order to expose the second conductor and/or the first conductor for conductively connecting the conductors to end connectors.

At least a portion of the outer jacket and at least a portion of the insulating jacket may be removed in order to prepare the first and the second conductors for connection to an end connector.

The end connectors or plugs may be of any suitable type for use with a musical instrument, a microphone, a speaker cable, a studio patch cable, etc., for example a mono connector (also known as a mono jack).

The audio cable may have one or two end connectors that are connected to the cable according to the methods described herein. In some embodiments, the audio cable may have a first and a second end connector. The first and the second end connectors may be of the same type, or of different types. In other embodiments, only one end of the cable has an end connector, the opposite of the cable may be finished and/or conductively connected in any manner of ways, for example connected to audio equipment.

The end connectors may include one or more contact regions. The contact regions may include a ground contact for providing a path to ground and one or more live regions configured for connection to a signal carrying conductor.

In some embodiments, the method comprises conditioning the end connector contact region with a contact conditioner. The contact conditioner may assist in the removal of any residue, contaminants, or oxidation products from the end connector prior to soldering.

As used herein, the term oxidation is understood to mean the process of oxidizing, i.e. a reaction with oxygen.

The contact conditioner may be used to clean and burnish the end connector contact region. The end connector contact region may include a live region of the end connector and/or a ground contact of the end connector.

The end connector contact region may be conditioned with any suitable contact conditioner or enhancer. For instance, the contact conditioner may be isopropyl alcohol-based, polymer-based, graphene-based, metal nanoparticle-based, or the like.

In some embodiments, the method comprises applying a solder and then a flux paste to the contact region of the end connector. Application of a solder to the contact region of the end connector before soldering, referred to as “tinning” prepares the end for soldering while the flux paste may aid in removing any oxidized metal from the surfaces to be soldered, improve wetting characteristics of liquid solder by facilitating amalgamation, and/or protect the molten solder from oxidation during the soldering process.

In some embodiments, an end of the first conductor and/or an end of the second conductor may be tinned prior to joining the conductors to the end connector. It will be understood that tinning comprises the application of a thin layer of solder to prevent oxidation of the exposed ends of the first or the second conductor before soldering. The solder used to tin the end of the first conductor and/or the end of the second conductor may be the same type as the solder applied to the contact region of the end connector.

The solder used to tin the end of the first conductor and/or the end of the second conductor may be the same type as the solder used to join an end of the conductor to the end connector to form a joint.

The solder may be applied to the contact region of the end connector using any suitable technique known in the art.

Any suitable solder may be used. The solder may comprise a conductive material, such as. a blend of silver, copper, tin and/or lead. The solder may comprise a rosin core.

Any suitable flux paste may be used. In some embodiments, the flux paste may comprise rosin or colophony. The flux paste may be activated.

The method comprises joining an end of the first conductor to a ground contact of the end connector to form a first joint, and joining the second conductor to a live region of the end connector to form a second joint, wherein the second conductor conducts an audio signal.

At least a portion of the first conductor may be twisted together so as to form a compact connection portion prior to joining the first conductor to a ground contact of the end connector.

The solder may be applied to join the end of the conductor to the end connector to form a joint using any suitable technique known in the art.

Any suitable solder may be used. The solder may comprise a conductive material. In some embodiments, the solder may comprise a blend of silver, copper, tin and/or lead. The solder may comprise a rosin core.

In some embodiments, the first joint and/or the second joint may be cleaned of any flux residue after soldering. While flux is an essential part of soldering, over time residue can cause contamination of the joints affecting the integrity and reliability of the connection. In addition, some flux pastes may be corrosive and may cause damage to sensitive systems.

The residual flux may be cleaned using any suitable process, for instance the residual flux may be physically removed (such as by brushing) or removed using a suitable solvent, e.g. isopropyl alcohol.

In some embodiments, the method comprises applying sealant to one or both of the first and second joints. In some embodiments, this may be done by coating one or both the first and second joints with a non-conducting sealant material, (i.e. an electrically insulating material) thereby hermetically sealing the cable joints so that the joints are protected from corrosion, oxidation, and/or other types of atmospheric attack in order to improve the audio signal. The coating comprises coating all exposed conductive components, including the inner and outer cable portions and where these portions are attached to the connector. The coating is applied so as to cover the joint between the cable and the connector up to the cable jacket so that a seal is formed between the cable jacket and the conductor. Advantageously, coating the cable joints with the non-conducting sealant material bonds the solder joints together and because the coating hermetically seals the joints it protects the joints from atmospheric attack providing a corrosion free connection.

Any suitable non-conducting coating and/or insulation material may be used as the sealant, or as part of the sealant. The non-conducting coating and/or insulation material may be dielectric and provide a barrier to the ingress of moisture, gases, and/or contaminants. The non-conducting coating and/or insulation material may be a paintable liquid or viscous insulating material. The use of a liquid coating and/or insulation material (as opposed to others forms of coating/insulation) is particularly useful because of the ease of application (e.g., via a paint brush), and how well the liquid is able to seal hard to reach parts of the joints.

The method may comprise curing the liquid sealant.

The liquid sealant may be cured between 10 minutes and 3 days, for example depending on the type of liquid sealant, the amount applied, and the ambient conditions (e.g. humidity and temperature). For example, the liquid sealant may be cured for about 30 minutes, about 1 hour, about 4 hours, about 8 hours, about 12 hours, about 16 hours, about 20 hours, or about 24 hours. In embodiments of the method described herein, the liquid sealant may be cured for about 24 hours.

The method may comprise applying heatshrink tube.

In embodiments, applying heatshrink tube comprises positioning the heatshrink tube about the end connector-conductor attachment and heating the heatshrink tube onto the end connector-conductor attachment. Applying heatshrink tube to the connection may provide additional insulation and increase strain relief where the cable exits the end connector which is a common stress point for every cable.

The method may further comprise positioning a second heatshrink tube about the first and/or second joint prior to positioning the heatshrink tube about the end connector-conductor attachment formed by the conductive connection secured between the end connector and the conductors. The second heatshrink tube may be the same type as the heatshrink tube, or may be of different types. Advantageously, providing the extra layer of heatshrink tube about the first and/or second joint further isolates the first and/or second joint and reduces signal leakage into the center conductor which could result in noise and disruption of the signal.

The method may further comprise applying insulation sleeve. The insulation sleeve may provide insulation between the end connector and an end connector housing, the housing configured to screw onto the end connector.

In a second aspect, there is provided a method of connecting an end connector to a respective end of a first and a second conductor of a cable having at least one of: a cable shield and a cable jacket, the method comprising:
joining an end of the first conductor to a ground contact of the end connector to form a first joint, and joining an end of the second conductor to a live region of the end connector to form a second joint, and
applying a sealant to the first joint and/or the second joint up to an edge of at least one of the cable shield and/or the cable jacket so that no gap remains between (a) the first and/or second conductor and (b) the cable shield and/or cable jacket of the cable in such a way as to hermetically seal the cable joints. Applying the sealant to a joint comprises applying the sealant to any exposed conductive material associated with the joint in order to insulate and hermetically seal the cable joint. In some embodiments this means that the sealant is applied up to the edge of a cable shield so that no gap remains between the cable shield and the inner conductive components of the cable. In some embodiments this means that the sealant is applied up to the connector so that no part of the attached first and second conductors remains exposed.

The method of connecting an end connector to a respective end of a first and a second conductor, wherein applying insulation comprises coating one or both the first and second joints with a liquid sealant, thereby hermetically sealing the cable joints so that the joints are protected from corrosion, oxidation, and/or other types of atmospheric attack.

In a third aspect, there is provided an audio cable when prepared according to the methods described herein.

A method of connecting an output jack to a respective end of a first and a second conductor comprising:
conditioning the output jack contact region with a contact conditioner;
applying a solder and then a flux paste to the contact region of the output jack;
joining an end of the first conductor to a ground contact of the output jack to form a first joint, and joining the second conductor to a live region of the output jack to form a second joint, and
coating the whole of one or both the first and second joints with a liquid sealant up to an edge of at least one of the cable shield and/or the cable jacket so that no gap remains between (a) the first and/or second conductor and (b) the cable shield and/or cable jacket of the cable to thereby hermetically seal the joints so that the joints are protected from corrosion, oxidation, and/or other types of atmospheric attack.

The output jack may be of any suitable type. For instance, the output jack may be a mono, stereo, TRS, barrel, power, or the like. In use, the output jack is configured to receive a cable therein.

The output jack may include one or more contact regions. The contact regions may include a ground contact for providing a path to ground, and one or more live regions configured for connection to a signal carrying conductor. For instance, the output jack may comprise at least one connection lug configured to contact the sleeve of the jack lead (ground contact) and at least one connection lug tip or primary lead (live or hot contact) connected to the tip arm which contacts the jack plug tip.

In use, wiring comprising a first conductor and a second conductor may be connected to the contact regions of the output jack.

In a fifth aspect, there is provided a method of connecting an output jack to a respective end of a first and a second conductor, the method comprising:
joining an end of the first conductor to a ground contact of the end connector to form a first joint, and joining an end of the second conductor to a live region of the end connector to form a second joint, and
applying insulation to the first joint and/or the second joint thereby hermetically sealing the cable joints

In a sixth aspect, there is provided an output jack when prepared according to the methods described herein.

The method may be applied to any electrical connection formed in guitar wiring. The method may be applied to a connection between one or more of a potentiometer (for example as used for volume and/or tone dials), a capacitor, a switch, and a guitar pickup or humbucker (i.e., the transducer). For example, the method may be applied to a connection between a first and a second conductor (i.e., a conducting pair) and a potentiometer in the guitar wiring, between a potentiometer and a switch, between a potentiometer and a guitar pickup or humbucker, between a conducting pair (e.g. the pickup) and a switch, between a conductor and a capacitor or resistor, between the start and finish wires and the pickup (or hookup) wires, or the like. The method may also be applied to the wiring for output sockets for guitars.

The method may be applied to any solder joint that is exposed when wiring up a guitar so that the soldered joints are enshrouded in electrical insulation that is easy and efficient to apply and effective in protecting the joints in order to maintain electrical signal quality and therefore ultimately also maintain audio signal quality.

In another aspect, a method of electrically connecting two conducting components in an audio circuit comprises connecting a conducting region of a first component to a conducting region of a second component to form an electrical joint; and applying a fluid dielectric around the electric joint so as to strengthen the joint and reduce degradation of an audio signal carried in the audio circuit.

Improving the connection between a cable and an end connector, thereby improving signal quality when using the cable, is achieved by sealing the joint between the cable conductors and the end connector. All exposed conducting surfaces are hermetically sealed so that no gas or liquid is able to reach the conducting parts exposed when the connector is attached to the conductors of the cable. This method is suitable for any type of cable and connector combination that might otherwise have parts of conducting material exposed in the cable-connector assembly. Such cables may be, for example, audio, USB (A, B, C, micro, mini, etc.), data, HDMI, Ethernet (RJ45), UF, DisplayPort, SATA, RCA, VGA, DVI, coaxial, and/or Thunderbolt cables.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

### BRIEF DESCRIPTION OF DRAWINGS

Embodiments of the disclosure are now described by way of example with reference to the accompanying drawings in which:

FIG. 1 illustrates a coaxial audio cable as known in the prior art.

FIG. 2 is a flow diagram of an embodiment of a method of manufacturing an audio cable having a first and a second end connector connected via a first and a second conductor.

FIGS. 3A-3F illustrate steps of a method of manufacturing an audio cable having a first and a second end connector connected via a first and a second conductor according to an embodiment:

FIG. 3A illustrates conditioning of the end connector contact region with a contact conditioner.

FIG. 3B illustrates applying a solder to the contact region of the end connector.

FIG. 3C illustrates applying a flux paste to the contact region of the end connector.

FIG. 3D illustrates joining an end of the first conductor to a ground contact of the end connector to form a first joint, and joining the second conductor to a live region of the end connector to form a second joint.

FIG. 3E and FIG. 3F illustrate coating one or both the first and second joints with a liquid sealant, thereby hermetically sealing the cable joints so that the joints are protected from corrosion, oxidation, and/or other types of atmospheric attack.

FIGS. 4A-4F illustrate optional steps to prepare the first and the second conductors for connection to the end connector:

FIG. 4A and FIG. 4B illustrate the removal of an outer jacket from an audio cable to expose a first conductor.

FIG. 4C illustrates the twisting of the first conductor to form a single conductor wire.

FIG. 4D illustrates the removal of an insulating jacket from the insulated second conductor.

FIG. 4E illustrates the removal of a further insulating jacket from the second conductor.

FIG. 4F illustrates the tinning of respective exposed ends of the first and the second conductor.

FIGS. 5A-5F illustrate optional steps to secure the cable to the end connector:

FIG. 5A and FIG. 5B illustrate closing of a cable clamp about the cable.

FIG. 5C and FIG. 5D illustrate applying heatshrink tube.

FIG. 5E illustrates applying insulation sleeve.

FIG. 5F illustrates screwing an end connector housing onto the end connector.

FIG. 6 shows one end of an audio cable prepared according to the method of FIG. 2.

FIG. 7 shows a wiring harness for a guitar as known in the prior art.

FIG. 8 shows an output jack for a guitar as known in the prior art.

FIG. 9 shows a wiring harness for a guitar as known in the prior art.

FIG. 10 shows an embodiment of a joint that includes first and second conductors of a cable joined to contacts of an end connector.

FIG. 11 shows the joint of FIG. 10 hermetically sealed by a liquid sealant.

FIG. 12 shows an embodiment of a joint that includes first and second conductors of a cable joined to contacts of an end connector, with the joint being hermetically sealed with a liquid sealant.

FIG. 13A shows a voltage output from a new sound cable.

FIG. 13B shows a voltage output from an old cable where the cable-connector joint is exposed.

FIG. 13C shows a voltage output from an old cable where the end connector is attached to the cable using an embodiment of a sealing method as described herein.

In the drawings, like reference numerals designate similar parts.

### DETAILED DESCRIPTION

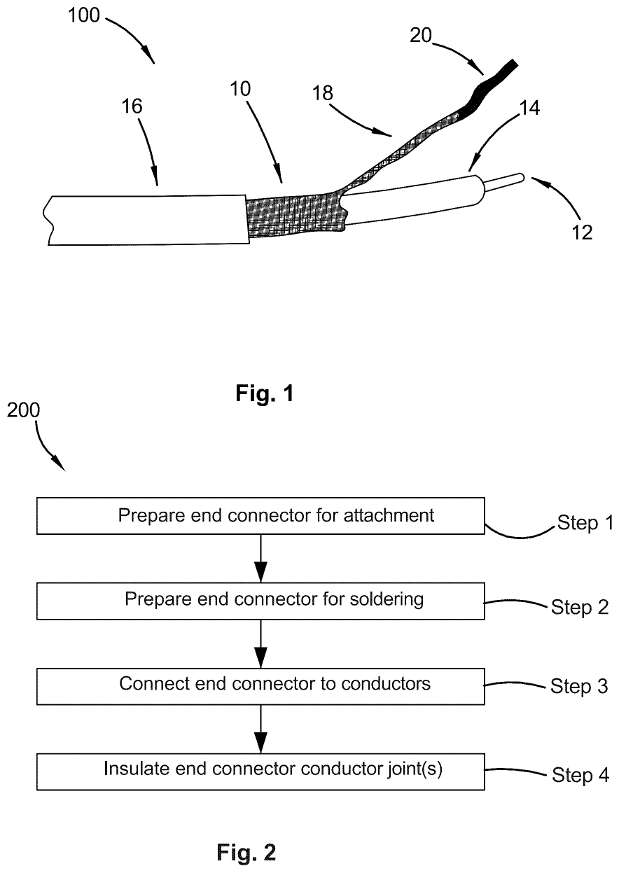

FIG. 1 shows a coaxial audio cable (100) as known in the prior art. Coaxial cable (100) comprises a first conductor (10) comprising a copper wire braided shield extending concentrically about and coaxially to a second conductor (12) comprising a solid copper wire or multiple strands of twisted copper wire. The second conductor (12) is provided with an insulating jacket (14) separating the first conductor (10) from the second conductor (12). The coaxial cable (100) is provided with an outer jacket (16) which provides environmental and mechanical protection to the conductors.

In preparation for attaching the cable to a connector, a portion of the outer jacket (16) of audio cable (100) has been removed to expose the first conductor. A portion of the copper wire braided shield of the first conductor (10) has been stripped back, thereby exposing the insulating jacket (14) of the coaxial cable (100), and the shield (10) is twisted together to form a compact connection portion (18). An exposed end (20) of the first conductor (10) has been tinned in preparation for joining to an end connector (not shown). A portion of the insulating jacket (14) has been removed from the second conductor (12) to expose the center conductor.

FIG. 2 shows a flow diagram of method (200) of manufacturing an audio cable having a first and a second end connector connected via a first and a second conductor.

In Step 1 of the method an end connector is prepared for attachment to a respective end of the conductors. In some embodiments, the end connector contact region is conditioned with a contact conditioner to prepare the end connector for attachment.

In Step 2 of the method, the end connector is prepared for soldering. Preparing the end connector for soldering may include applying a solder and/or a flux paste to the contact region of the end connector. This step is optional for embodiments where the end connector and the conductors are soldered together. This step may be omitted in embodiments where the end connector and conductors are attached using methods other than soldering (for example twisting together, clipping together, adhering with a conductive glue, etc.).

In Step 3 of the method, the end connector and conductors are connected together. In some embodiments, this is done by joining an end of the first conductor to a ground contact of the end connector to form a first joint, and an end of the second conductor is joined to a live region of the end connector to form a second joint. This may be done via soldering.

In Step 4 of the method, the joint(s) formed between the end connector and the conductors are sealed. In some embodiments, this may be done by coating one or both of the first and second joints with a non-conducting sealant material, such as a liquid sealant, thereby hermetically sealing the cable joints so that the joints are protected from corrosion, oxidation, and/or other types of atmospheric attack. In some embodiments, the joint is coated in a dielectric sealant. The dielectric sealant may include STARBRITE® liquid electrical tape. The dielectric sealant may comprise one or more of: Xylenes (o-, m-, p-isomers), 2-Butanone, Propanol, oxybis-, dibenzoate, Acetone, and Talc. The dielectric sealant may comprise one or more of xylene, toluene, butanone, MEK or other similar solvent. The dielectric sealant may comprise at least 30% X The dielectric sealant may have a suitable viscosity so as to be paintable onto the joint.

The dielectric sealant may comprise one or more of: liquid polymeric insulation compounds, epoxy encapsulants, MIL-L-87177 CPC (Super Corr-A/B), MIL-PRF-81309, MIL-PRF-16173, and silicone compounds.

The whole joint is sealed so that all conductive portions in the joint are covered and do not remain exposed to the environment. For example, a liquid sealant may be applied to coat the joints between the cable conductors and the end contacts of a connector, with a coat applied over the braided shield of the cable and onto the PVC jacket. Coating both joints (for both conductors of the cable) ensures hermetic sealing thereby protecting the cable joint from atmospheric attack.

In some embodiments, the dielectric sealant is a fluid, a liquid, and is viscous, so as to be paintable.

In some embodiments, the sealant may comprise one or more of: an epoxy sealant, a polyurethane sealant, an acrylic sealant, a silicone sealant, a bituminous sealants (such as an asphalt-based sealant), and/or a corrosion inhibiting sealant (such as a zinc-rich, phosphate-based, or chromate-based sealant).

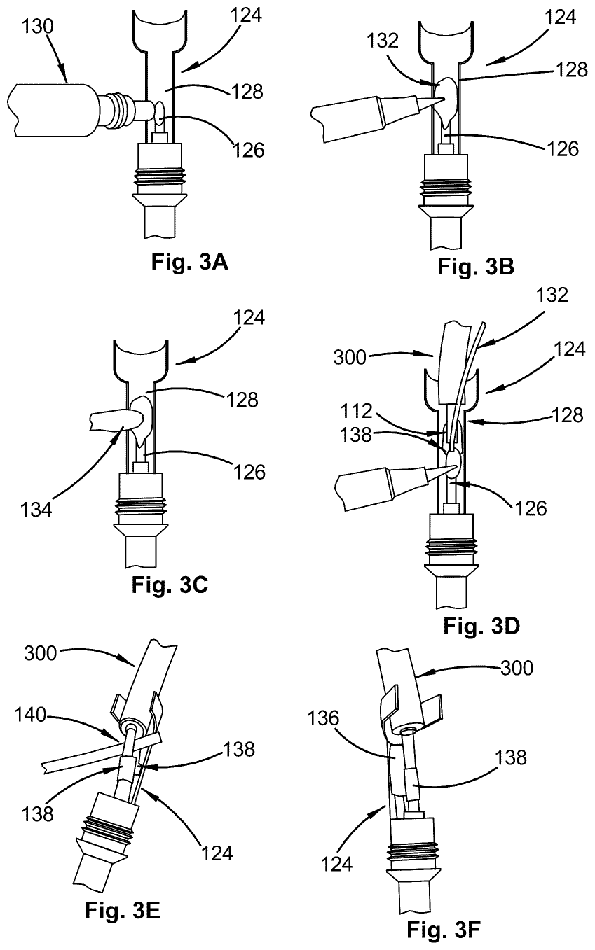

FIG. 3A to FIG. 3F illustrate steps of a method of manufacturing and/or repairing an audio cable having a first and a second end connector connected via a first and a second conductor according to an embodiment.

Referring to FIG. 3A, the contact region (126) of an end connector or plug (124) is conditioned with a contact conditioner.

In FIG. 3B and FIG. 3C, a solder (132) and then a flux paste (134) are applied to the contact region (126) of the end connector (124) and to the ground contact (128) of the end connector (124) to prepare the end connector for connection to the first and the second conductors of the cable. One or both of these steps may be omitted.

FIG. 3D shows solder (132) being applied using a soldering iron. The first conductor (110) and the second conductor (112) of audio cable (300) are brought into contact with end connector (124). An end (120) of the first conductor (110) is joined to a ground contact (128) of the end connector (124) to form a first joint (126). An end of the second conductor (112) is joined to a contact region (126) of the end connector to form a second joint (138).

The first and/or second joints (136,138) are coated with a non-conducting sealant (140), thereby hermetically sealing the cable joints so that the joints are protected from corrosion, oxidation, and/or other types of atmospheric attack (FIG. 3E and FIG. 3F). The non-conducting sealant material may be a liquid sealant. In other embodiments, other forms of insulation may be applied, such as insulation tape, although this would need to be applied extensively and thoroughly in order to seal all exposed conductive portions of the joint.

In some embodiments, the sealing step may comprise hermetically sealing both joints as well as the stripped cable shield up to an edge of the cable jacket so that all areas exposed to the environment are sealed.

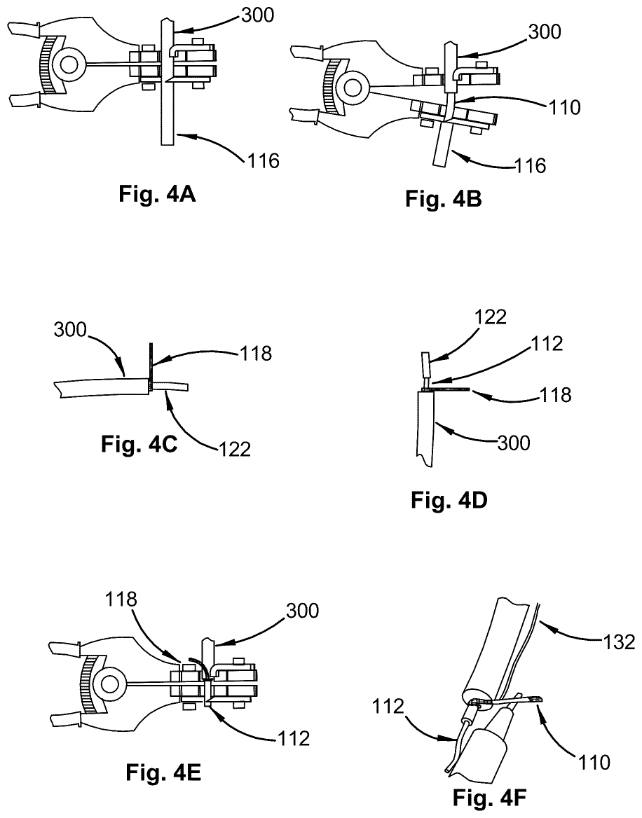

FIG. 4A to FIG. 4F of the drawings illustrate optional steps that may, for some embodiments of the method, be suitable to prepare the first and the second conductors for connection to the end connector. Outer jacket 116 is removed from audio cable (300) to expose a copper wire braided shield of first conductor (110). The first conductor (110) is twisted together to form a compact connection portion (118). Removal of the first conductor (118) exposes an insulating jacket (122) around insulated second conductor (112). Clear insulating jacket (114) is removed from the center conductor (112) to expose the second conductor. An exposed end of first conductor (110) and an exposed end of second conductor (112) may be tinned with solder in preparation for joining the conductors to an end connector, as illustrated in FIG. 4F.

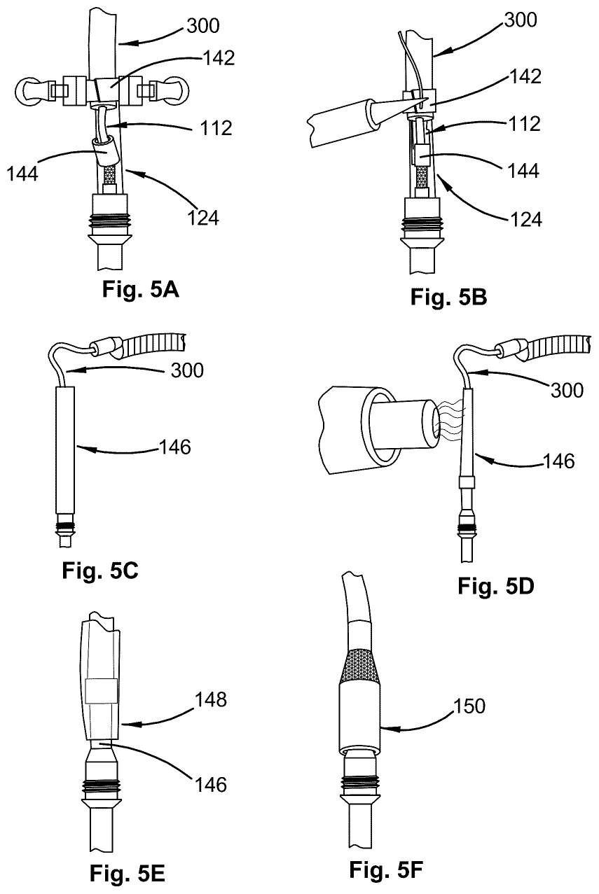

Referring to FIG. 5A to FIG. 5F of the drawings, optional steps to secure the cable to the end connector for use are illustrated.

As illustrated in FIG. 5A and FIG. 5B, in embodiments where a cable clamp (142) forms part of end connector (124), the cable clamp is closed about the audio cable (300) to secure the cable to the end connector. Optionally, one or more of a conditioner, solder, or flux paste may be applied to the cable clamp prior to soldering the cable clamp to close the clamp about the audio cable and secure the cable to the end connector. Optionally, a heatshrink tube (144) may be applied about the second joint (138) to provide additional strength and insulation directly to the joint. Suitable heatshrink tubes may include non-conductive polymeric heatshrink tubes, non-conductive rubber heatshrink tubes, electrical tape, and/or liquid sealant.

Referring to FIG. 5C and FIG. 5D, a heatshrink tube (146) is applied over the cable-end connector connection and heat applied to shrink it onto the connection. This may provide additional insulation and increase strain relief where the cable exits the end connector which is a common stress point for audio cables. The insulation and support provided by the heatshrink tube may be provided by non-conductive polymeric heatshrink tubes or non-conductive rubber heatshrink tubes. Alternatively or additionally, electrical tape, and/or liquid sealant may be applied.

In FIG. 5E, an insulated sleeve (148) is positioned over the heatshrink tube (146). The insulation sleeve provides insulation between the end connector and end connector housing. Suitable insulated sleeves may include a non-shrink polymeric tube, a heatshrink tube, and/or electrical tape.

In FIG. 5F, the end connector housing (150) is attached to (e.g. screwed onto, friction fit, etc.) the end connector to form the finished audio cable.

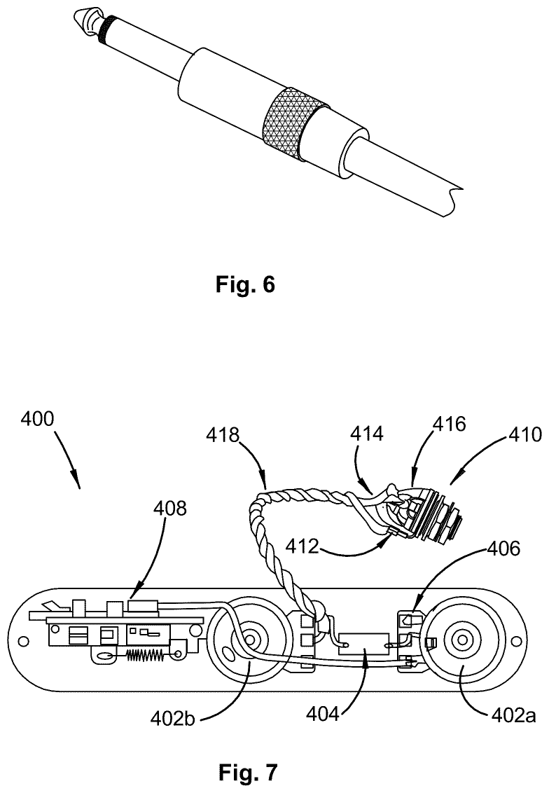

FIG. 6 shows the connected mono jack of one end of an audio cable prepared according to the method.

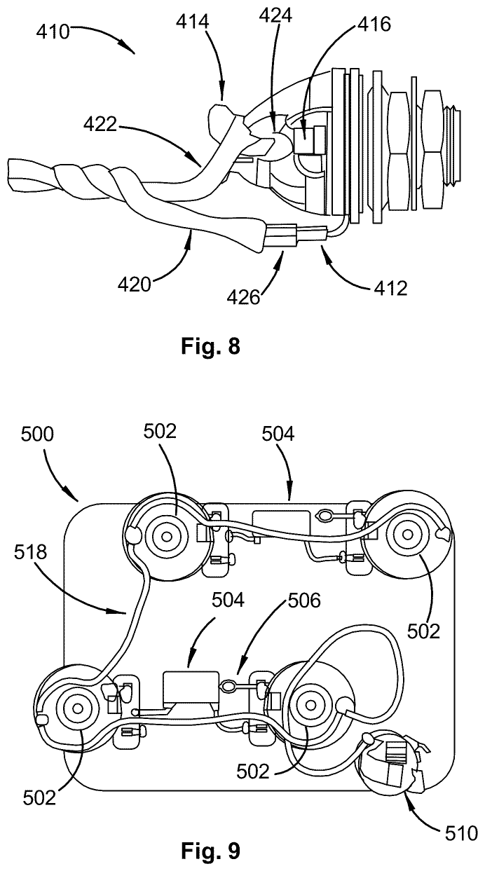

FIG. 7 shows a wiring harness for a guitar as known in the prior art and FIG. 8 shows an output jack when used with the wiring harness for a guitar. Wiring harness (400) comprises volume and tone potentiometers (402a,402b), a capacitor (404) and a switch (408) connected to the potentiometer's connecting lugs (406) via wiring. Output jack (410) is connected to the wiring harness (400) by wiring (418).

Output jack (410) includes a ground contact region including a ground lug (416) which is part of a central conducting section which in use contacts the sleeve of a jack plug (not shown), and a live or hot contact region including a live lug (412) connected to a tip arm (414) and configured to contact the tip of the jack plug (not shown). Wiring comprising a twisted pair of a first and a second conductor (420,422) encased in insulating jackets connects the live and the ground contacts (412,416) to the wiring harness (400).

As can be seen in FIG. 8 of the drawings, contact regions (412, 416) of output jack (400) may be conditioned with a contact conditioner to prepare for attachment to a conductor. A solder, and then a flux paste may be applied to the contact regions (412,416) of the output jack (400). The contact regions (412,416) and the first and the second conductors (420,422) are connected together by joining an end of the first conductor (422) to the ground contact lug (416) to form a first joint (424), and an end of the second conductor (420) to a live contact plug (412) to form a second joint (426). This may be done via soldering. The first joint (424) and the second joint (426) formed between the output jack (400) and the conductors (420,422) may be insulated. This may be done by coating one or both of the first and second joints with a sealant material, thereby hermetically sealing the joints so that the joints are protected from corrosion, oxidation, and/or other types of atmospheric attack. The sealant material may include or be a liquid sealant. The sealant is non-conducting to act as an insulator.

FIG. 9 shows a wiring harness for a guitar as known in the prior art. Wiring harness (500) comprises two volume and two tone potentiometers (502), two capacitors (504), and an output jack (510) connected via wiring (518). In use the pickup wire is connected to the potentiometers, and may also be connected to a switch (not shown).

### EXAMPLE

The below Example is described with reference to the drawings. The person skilled in the art will appreciate that not all of the below steps are required and the actual steps may vary depending on, for example, the type of audio cable, attachment mechanism, selected preparation means, and end connector(s) used.

A coaxial audio cable is prepared for connecting to an end connector by removing an outer jacket from the cable (FIG. 4A to FIG. 4B) to expose an outer shield in the form of a braided copper wire. The outer shield may extend concentrically about and coaxially to the center conductor of the audio cable.

After removing the outer jacket from the shield, the shield may be twisted together to form a single conductor wire (FIG. 4C).

The signal-carrying center conductor is separated from the shield by an insulating jacket which surrounds the center conductor. The center conductor comprises a multi-strand twisted copper wire or a solid copper wire.

The insulating jacket is removed from the center conductor to expose the center conductor (FIG. 4D to FIG. 4E), and if necessary, the center conductor may be twisted together to form a single conductor wire.

An exposed end of the shield and an exposed end of the center conductor are tinned using Cardas™ Quad Eutectic Silver Solder in preparation for joining to an end connector (FIG. 4F). In this instance, it will be understood that tinning describes the application of a thin coat of solder to the exposed copper to prevent the conductors from oxidizing before soldering. Any suitable solder may be used.

The copper plug contact (live region) of an end connector is first cleaned and burnished using Cardas™ Contact Conditioner to remove any residue, contaminants or oxidation products (FIG. 3A). The ground contact region of the end connector may also be conditioned using the contact conditioner. The end connector may be a mono connector (also called a mono jack), as is used for TS cables. In some embodiments the methods described herein may be used for TRS cables and/or TRRS cables, and the end connector may be a TS jack. In some embodiments, the end connector may be a microphone 3 Pin XLR connector and/or a SPEAKON® connector.

After cleaning, to prepare the plug contact for a soldered connection to a cable conductor, the plug contact is optionally tinned with Cardas™ Quad Eutectic Silver Solder or other suitable solder (FIG. 3B). Subsequently, the tinned plug contacts are coated with Cardas™ rosin flux soldering paste or other suitable flux which protects the molten solder from oxidation during the soldering process (FIG. 3C).

An end of the tinned shield is then joined to a ground contact of the end connector by making a first soldered connection between the conductor and the end connector using Cardas™ Quad Eutectic Silver Solder or other suitable solder (FIG. 3D). An end of the tinned center conductor is joined to a live region of the tinned plug contact by making a second soldered connection between the conductor and the end connector using Cardas™ Quad Eutectic Silver Solder or other suitable solder (FIG. 3D).

In this way, a conductive connection is secured between the end connector and the conductors, thereby forming an end connector-conductor attachment.

In alternative embodiments, the conductive connection may be made without soldering the conductors to the end connector, for example using a conductive glue, twisting together, or otherwise connecting the conductors to the end connector.

An initial soldered connection between the conductor and the end connector may be made and checked for correct alignment and position before the soldered connection is completed.

The first and the second soldered connection joint may be inspected under a magnifying lamp for the quality of the soldered connection and for flux residue. Any residual flux may then be removed as it may affect the integrity of the connection or quality of the connection. The soldered connections, surface of the end connector, and ends of the first and second conductors can be cleaned and burnished with a contact conditioner to remove residual flux, or the residual flux can be physically removed by brushing.

STARBRITE® liquid electrical tape is applied to each of the first and second joints (FIG. 3E to FIG. 3F). This liquid sealant seals the cable joints so that the joints are protected from corrosion, oxidation, and/or other types of atmospheric attack.

Advantageously, sealing the cable and joints provides a permanent, reliable connection of high electrical and sonic integrity. Dielectric liquid sealant such as liquid electrical tape has the added benefit of supporting electrical joints to be vibration-resistant, thereby strengthening the joints.

The liquid sealant is allowed to cure for about 24 hours. Other types of liquid sealant may be cured for longer or shorter. Curing times may vary dependent on other factors including humidity, temperature, amount of insulation used, etc. Some types of insulation may not require any curing.

Other types of insulation may be used, such as a dielectric coating, a liquid dielectric coating, a dielectric sealant, insulation tape, electrical tape, liquid rubber spray, melting rubber heatshrink tube, vinyl paint, vinyl polymer sealant, liquid silicon-based products, insulating varnishes (such as those used with transformers), non-conductive coatings and paints, non-conductive sealant coatings, non-conductive silicon-based products, non-conductive vinyl polymer products, thread locker coating, and LOCTITE® threadlocker.

If present, a cable clamp of the end connector is closed about the audio cable to secure the cable to the end connector (FIG. 5A to FIG. 5B). Conditioning a cable clamp of the end connector, tinning a cable clamp of the end connector, and/or applying a flux paste to a cable clamp of the end connector may be conducted prior to soldering the cable clamp to close the cable clamp about the audio cable and secure the cable to the end connector. The cable clamps are soldered to provide strain relief for the soldered connections, as any pressure applied to the lead by pulling or twisting is not transferred to the insulated connections. In other embodiments the cable clamp may be secured without soldering.

A Voltage Cable Co. heatshrink tube is applied over the cable-end connector connection (end connector-conductor attachment) and heat applied to shrink it onto the connection (FIG. 5C to FIG. 5D). Alternatively, a tin or other metal spring may be applied over the cable-end connector connection.

In some instances, a second heatshrink tube may be applied directly over the first and/or second joint before heatshrink tube is applied over the cable-end connector connection (FIG. 5A to FIG. 5B). Suitable heatshrink tubes may include non-conductive polymeric heatshrink tubes and/or non-conductive rubber heatshrink tubes. Electrical tape, and/or liquid sealant may also be used.

A G&H insulated sleeve is positioned over the heatshrink tube (FIG. 5E) before an end connector housing is screwed onto the end connector (FIG. 5F). Providing an insulated sleeve to the connection provides insulation between the end connector and the end connector housing, as well as solid protection for the cable-end connector connection. In alternative embodiments, other insulating means may be used, including insulation tape, a heatshrink tube, or other polymeric tubing.

The capacitance, inductance and resistance of the finished audio cable are measured for electrical tolerance. The lead is also tested for sonic integrity with an amplifier and electric guitar using various pickup configurations.

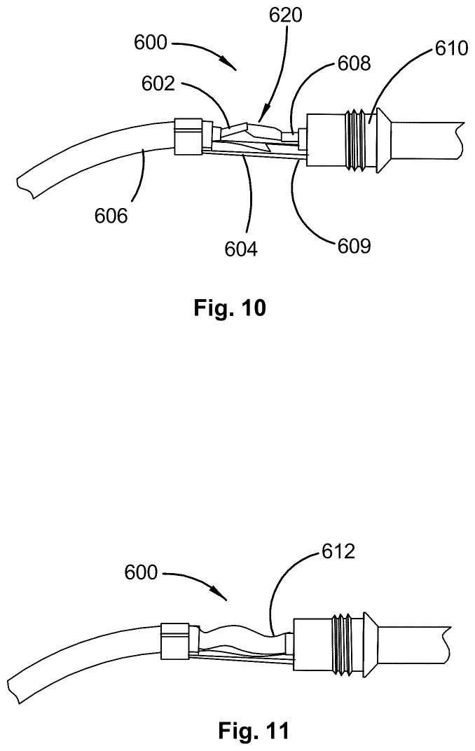

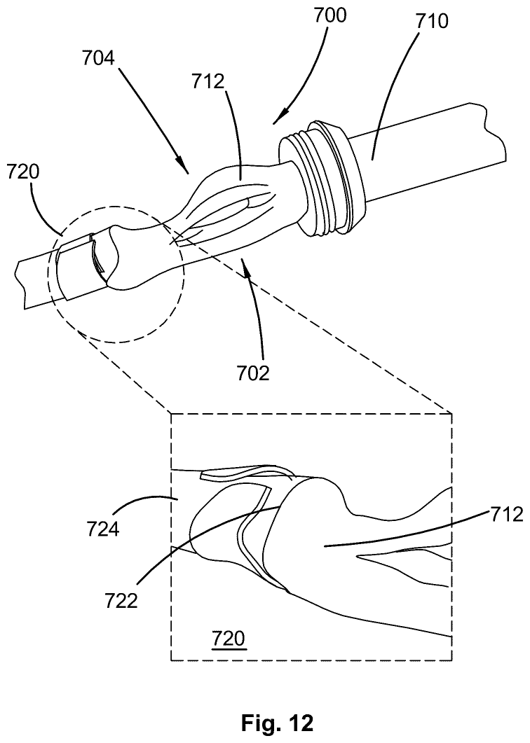

FIG. 10 shows an embodiment of a joint (600) that includes first (602) and second (604) conductors of a cable (606) joined to respective contacts (608, 609) of an end connector (610). The inner conductive components (620), which include the conductors (602, 604) and the contacts (608, 609) are exposed. FIG. 11 shows the joint (600) of FIG. 10 hermetically sealing these inner conductive components (620) via the application of a liquid sealant (612).

FIG. 12 shows an embodiment of a joint (700) that includes first (702) and second conductors (704) of a cable joined to respective contacts of an end connector (710), with the joint being hermetically sealed with a liquid sealant (712). As can be seen in the enlarged portion (720), the sealant (712) is applied up to the edge (722) of the cable shield (724) so that no gap remains between the cable shield (724) and the inner conductive components of the cable (no longer visible). Hermetically sealing both joints as well as the stripped cable shield up to an edge of the cable jacket means that all areas previously exposed to the environment are now sealed.

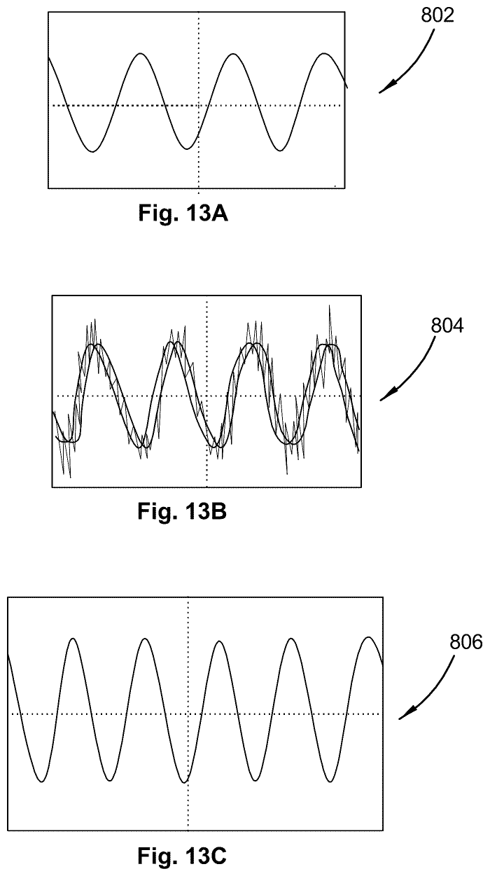

FIG. 13A shows a voltage output 802 from a new sound cable. The signal is “clean”, with no visible noise or other signal degradation visible. FIG. 13B shows a voltage output 804 from an old cable where the cable-connector joint is exposed. As can be seen by the noise visible on the measured signal, the exposed cable, suffering from corrosion and/or oxidation due to atmospheric attack, results in signal degradation. In cables used for audio applications this results in distorted sound. FIG. 13C shows a voltage output (806) from an old cable where the end connector is attached to the cable using the sealing method described herein. As can be seen, the integrity of the cable has been maintained, and this is because the conducting components of the cable and the joint have not been exposed to corrosive effects.

Embodiments described herein include examples of audio cables. Beyond audio cables, the reliability and quality of connections are critical for a wide range of electronic cables. Poorly made or degraded connectors can cause resistance, intermittent connections, signal loss, or electrical noise, compromising overall system performance. Repeated mechanical stress, environmental exposure, or low-quality materials can accelerate such degradation, underscoring the need for connectors and cables with durable materials, precise construction, and protective features that ensure consistent electrical and mechanical integrity. The method described herein, and in particular the use of a sealant to hermetically seal any exposed conductor material, may be used for any of the following types of cables:
a. Audio/Video Cables
   i. Audio cables (instrument, microphone, speaker, patch cables)
   ii. RCA cables (analog audio/video)
   iii. HDMI cables (high-definition multimedia interface)
   iv. DisplayPort cables
   v. VGA cables (analog video)
   vi. DVI cables (digital video interface)
   vii. Component video cables (YPbPr)
   viii. Composite video cables
   ix. Coaxial cables (RF signal transmission, TV, internet)
b. Data and Communication Cables
   i. USB cables (USB-A, USB-B, USB-C, USB 3.x, USB 4, micro, mini)
   ii. Thunderbolt cables (copper versions for short-range, high-speed data/video)
   iii. Ethernet cables (Cat5e, Cat6, Cat6a, Cat7, Cat8 twisted pair)
   iv. RS-232/Serial cables
   v. SATA cables (Serial ATA for storage devices)
   vi. Fire Wire/IEEE 1394 cables
   vii. MIDI cables (musical instrument digital interface)
   viii. Telephone cables (RJ11, 2-wire or 4-wire copper lines)
   ix. CAN bus cables (automotive and industrial networks)
c. Power Cables
   i. AC power cords (appliances, computers)
   ii. DC power cables (electronics, solar, automotive)
   iii. Speaker wires (home theater, studio monitors)
   iv. Automotive wiring harnesses
   v. UF (underground feeder) cables
d. Specialty Cables
   i. Coaxial RG-series cables (RG-6, RG-59, RG-11)
   ii. Industrial control cables (multiconductor copper cables for machinery)
   iii. Security/alarm system cables
   iv. Audio/Video hybrid cables (combined power and signal in one jacket)
   v. USB over Cat cables (for extending USB via Ethernet-type twisted pair)

Advantageously, the methods described herein comprise hermetically sealing cable joints, and the cables described herein comprise hermetically sealed joints and/or hermetically sealed joints with connectors.

Advantageously, the methods and cables described herein result in longer lasting audio cables of all types. Cables made and/or repaired using the hermetically sealing methods described herein (in particular the cable joints, for example where the cables are joined to connectors) result in better audio quality than audio cables where parts of the joints remain exposed, and those connections remain intact for longer. Applying a sealant, especially a liquid or viscous form, aids in enhancing the longevity and integrity of the cable and plug assembly as a whole working audio product.

Advantageously, the methods described herein include coating both joints and also hermetically sealing the whole assembly, including up to the cable shield and jacket of the cable to properly ensure a hermetic seal and prevent oxidation and corrosion. This prevents oxidation of the conductive material, thereby reducing signal (and harmonic) distortion, which is particularly important in audio cables.

In contrast to prior art solder joints that weaken over time to a point of failure, joints formed according to the methods described herein are protected from atmospheric attack so that the assembly is strengthened and longevity is enhanced.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

1. A method of connecting an end connector to a respective end of a first and a second conductor of a cable having at least one of: a cable shield and a cable jacket, the method comprising:
conditioning the end connector contact region with a contact conditioner;
applying at least one of a solder and a flux paste to the contact region of the end connector;
joining an end of the first conductor to a ground contact of the end connector to form a first joint, and joining the second conductor to a live region of the end connector to form a second joint, wherein the second conductor conducts an audio signal, and
coating one or both the first and second joints with a sealant up to an edge of at least one of the cable shield and the cable jacket so that no gap remains between (a) the first and/or second conductor and (b) the cable shield and/or cable jacket of the cable to thereby hermetically seal the joints so that the joints are strengthened and protected from corrosion, oxidation, and/or other types of atmospheric attack.

2. The method according to claim 1, wherein the sealant comprises a flowable, pourable, dispensable, brushable, conformable, coatable, malleable, liquid or viscous insulation, and the method further comprises curing the insulation.

3. The method according to claim 1, further comprising applying heatshrink tube.

4. The method according to claim 3, wherein applying heatshrink tube comprises positioning the heatshrink tube about the end connector-conductor attachment and heating the heatshrink tube onto the end connector-conductor attachment about the sealant so as to cover the sealant applied to the joints.

5. The method according to claim 4, wherein a second heatshrink tube is positioned about the second joint prior to positioning the heatshrink tube about the end connector-conductor attachment.

6. The method according to claim 1, further comprising applying an insulation sleeve.

7. A method of connecting an end connector to a respective end of a first and a second conductor of a cable having at least one of: a cable shield and a cable jacket, the method comprising:
joining an end of the first conductor to a ground contact of the end connector to form a first joint, and joining an end of the second conductor to a live region of the end connector to form a second joint, wherein the second conductor conducts an electrical signal; and
applying a sealant to the first joint and/or the second joint up to an edge of at least one of the cable shield and/or the cable jacket so that no gap remains between (a) the first and/or second conductor and (b) the cable shield and/or cable jacket of the cable to thereby hermetically seal the cable joints.

8. The method of claim 7, wherein applying the sealant comprises coating one or both the first and second joints with a dielectric so that all areas exposed to the environment are sealed, thereby hermetically sealing the cable joints so that the joints are protected from corrosion, oxidation, and/or other types of atmospheric attack in order to improve the audio signal.

9. The method of claim 7, wherein the sealant comprises a dielectric sealant comprising a solvent selected from the group comprising: xylene, toluene, butanone, MEK and acetone.

10. A cable prepared according to the method of claim 1.

11. A method of connecting a connector to a respective end of a first and a second conductor of a cable having at least one of: a cable shield and a cable jacket, the method comprising:
conditioning a contact region of the connector with a contact conditioner;
applying a solder and then a flux paste to the contact region of the connector;
joining an end of the first conductor to a ground contact of the connector to form a first joint, and joining the second conductor to a live region of the connector to form a second joint, and
coating one or both the first and second joints with a sealant up to an edge of at least one of the cable shield and/or the cable jacket so that no gap remains between (a) the first and/or second conductor and (b) the cable shield and/or cable jacket of the cable to thereby hermetically seal the joints so that the joints are protected from corrosion, oxidation, and/or other types of atmospheric attack.

12. The method according to claim 11, wherein the sealant comprises a flowable, pourable, dispensable, brushable, conformable, coatable, malleable, liquid or viscous sealant, and the method further comprises curing the sealant.

13. The method according to claim 11, further comprising applying heatshrink tube.

14. The method according to claim 13, wherein applying heatshrink tube comprises positioning the heatshrink tube about the end connector-conductor attachment and heating the heatshrink tube onto the end connector-conductor attachment about the applied sealant covering the joint.

15. The method according to claim 14, wherein a second heatshrink tube is positioned about the second joint prior to positioning the heatshrink tube about end connector-conductor attachment.

16. The method according to claim 11, further comprising applying insulation sleeve.

17. A method of connecting a connector to a respective end of a first and/or a second conductor of a cable having at least one of a cable shield and a cable jacket, the method comprising:
joining an end of the first conductor to a ground contact of the end connector to form a first joint, and/or joining an end of the second conductor to a live region of the end connector to form a second joint, and
applying insulation to the first joint and/or the second joint up to an edge of at least one of the cable shield and the cable jacket so that no gap remains between (a) the first and/or second conductor and (b) the cable shield and/or cable jacket of the cable to thereby hermetically seal the cable joints.

18. The method of claim 17, wherein applying insulation comprises coating one or both the first and second joints with a sealant, thereby hermetically sealing the cable joints so that the joints are protected from corrosion, oxidation, and/or other types of atmospheric attack.

19. The method of claim 17, wherein the cable is one of: an audio, USB, data, HDMI, Ethernet (RJ45), UF, DisplayPort, SATA, RCA, VGA, DVI, coaxial, and Thunderbolt cables.

20. A method of electrically connecting two conducting components in circuit, the method comprising:
connecting a conducting region of a first component to a conducting region of a second component to form an electrical joint; and
applying a sealant around the electric joint, sealing all conductive components in the electric joint, so as to strengthen the joint and reduce degradation of a signal carried in the circuit.

21. The method of claim 20, wherein the sealant comprises a fluid dielectric, and wherein the fluid dielectric comprises a liquid electrical insulating tape.

22. The method of claim 20, wherein the sealant comprises a non-conductive coating.

23. The method of claim 20, wherein the circuit is an audio circuit, and wherein the signal is an audio signal.
